(19) United States
(12) Patent Application Publication
(10) Pub. No.: US 2018/0239483 A1
(43) Pub. Date: Aug. 23, 2018

(54) POSITION CONTROL TOUCHSCREENS FOR VEHICLES

(71) Applicant: Ford Global Technologies, LLC, Dearborn, MI (US)

(72) Inventors: Ronald Patrick Brombach, Plymouth, MI (US); Bryan Nikiforuk, Warren, MI (US); Kyle Schmidt, Grosse Pointe Woods, MI (US)

(21) Appl. No.: 15/438,627

(22) Filed: Feb. 21, 2017

(51) Int. Cl. G06F 3/041; B60N 2/02; B62D 1/181; B60R 1/072; B60K 37/02; E05F 15/60; E05B 81/56; G05G 1/405

(52) U.S. Cl. CPC G06F 3/0416; B60N 2/0232; B62D 1/181; B60R 1/072; G05G 2700/02; E05F 15/60; E05B 81/56; G05G 1/405; B60K 2350/1028; B60K 37/02

(57) ABSTRACT

Method, apparatus, and computer readable media are disclosed for position control touchscreens for vehicles. An example vehicle includes a center console touchscreen for controlling vehicle settings, a seat, a seat motor coupled to the seat, a position control touchscreen adjacent to the seat for controlling seat settings, and a position adjuster communicatively coupled to the position control touchscreen. The position adjuster is to receive a seat adjustment command from the position control touchscreen and adjust the seat, via the seat motor, based on the seat adjustment command.

### TECHNICAL FIELD

The present disclosure generally relates to touchscreens, more specifically, position control touchscreens for vehicles.

### BACKGROUND

Typically vehicles, such as cars, include a plurality of adjustable devices. For example, a position of a seat, a steering wheel, pedals, windows, etc. may be adjustable. Oftentimes, the positions of such devices are adjustable electronically via switches and/or buttons. In some instances, the switches and or buttons are grouped together in a cluster on an interior surface of the vehicle.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

An example vehicle includes a center console touchscreen for controlling vehicle settings, a seat, a seat motor coupled to the seat, a position control touchscreen adjacent to the seat for controlling seat settings, and a position adjuster communicatively coupled to the position control touchscreen. The position adjuster is to receive a seat adjustment command via the position control touchscreen and adjust the seat, via the seat motor, based on the seat adjustment command.

A tangible computer readable medium includes instructions which, when executed, cause a vehicle to receive, via a center console touchscreen, vehicle setting control commands and receive, via a position control touchscreen, a seat adjustment command. The instructions, when executed, also cause the vehicle to determine, via a processor, a seat adjustment instruction for a seat motor coupled to a seat based on the seat adjustment command and adjust, via the seat motor, a seat setting based on the seat adjustment instruction.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is an interior view of a vehicle that includes an example position control touchscreen in accordance with the teachings herein.

FIG. 2 is a cutaway view of the vehicle of FIG. 1.

FIG. 3 is a block diagram of the electronic components of the vehicle of FIG. 1.

FIG. 4 is a flowchart of a method to implement the example position control touchscreen of FIG. 1.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

In a vehicle, such as a car, the position of certain devices (e.g. a seat, a steering wheel, gas and/or brake pedals, etc.) is oftentimes electrically adjustable. The adjustment is typically accomplished by moving part of the device via motors to achieve a desired position (e.g. raising the pedals, reclining the seat, etc.). The number of motors is proportional to the number of possible adjustments. For example, a vehicle may have ten or more motors for adjusting a seat and three or more motors for adjusting positions of pedal(s) and a steering wheel.

In some instances, the vehicle includes a switch for each potential adjustment. In some such instances, the vehicle may have twenty or more switches to control seat position and an additional six switches to control positions of pedal(s) and a steering wheel. Such an array of switches potentially may be unintuitive or difficult for a user to use. Switches that are located out of sight (e.g. on the side of the seat) potentially may be further difficult to use. Alternatively, in some vehicles, adjustments may be performed via a center console touchscreen. In such instances the center console also controls a climate control system, an entertainment system, a navigation system, a communication system, etc. of the vehicle. Because of the center console touchscreen controls a great number of vehicle settings, navigation of the center console touchscreen to menus that adjust settings of the seat, steering wheel, pedals, etc. potentially can be time consuming.

An example system as disclosed in more detail below provides a position control touchscreen that is adjacent to a seat. The position control touchscreen is a dedicated interface for making seat adjustments, steering wheel adjustments, pedal adjustments, window adjustments, mirror adjustments, and/or door lock state adjustments, etc. A center console touchscreen facilitates controlling vehicle settings. As used herein, “vehicle settings” include any adjustable vehicle option or configuration (e.g. settings for climate control, the entertainment system, the navigation system, the communication system, driving mode, etc.) except for a seat adjustment, a steering wheel adjustment, a pedal adjustment, a window adjustment, a door lock state, a mirror adjustment and/or any other adjustment controlled by the position control touchscreen. The system uses the position control touchscreen that is coupled to a door or to a seat to provide a convenient and intuitive interface for a user to adjust a few designated vehicle devices. The position control touchscreen visually depicts the device to be adjusted and receives a command in the form of the user's touch. For example, the user may recline his seat by touching the image corresponding to a seat back on the position control touchscreen and dragging it to a desired angle. Based on the received command, a position adjuster determines a corresponding instruction to effect the desired adjustment of a target device. After determining the command and target device, the position adjuster sends the command to a motor controller (e.g. a seat motor controller) coupled with the target device. Upon receiving the command, the motor controller performs the requested adjustment by causing the necessary motors to rotate. For example, when the position control touchscreen receives a command to adjust the seat, the position adjuster sends instructions to the seat motor controller to control seat control motors such that the seat is adjusted. Additionally, the display on the position control touchscreen updates to reflect the changed position of the target device.

Example vehicles disclosed herein include a center console touchscreen for controlling vehicle settings, a seat (e.g. a driver seat), a seat motor coupled to the seat, and a position control touchscreen adjacent to the seat for controlling seat settings. A position adjuster is communicatively coupled to the position control touchscreen. The position adjuster is to receive a seat adjustment command (e.g. a predefined user configuration) via the position control touchscreen and adjust the seat, via the seat motor, based on the seat adjustment command.

In some examples, the position control touchscreen displays a current position of the seat. Further, the position control touchscreen is coupled to the door. In other examples, the position control touchscreen is coupled to the seat.

In some examples, the vehicle includes a second seat, a second seat motor coupled to the second seat, and a second position touchscreen adjacent to the second seat for controlling seat settings of the second seat. In such examples, the position adjuster adjusts the second seat, via the second seat motor, based on a second seat adjustment command received via the second position control touchscreen.

Further, in some examples, the vehicle includes a steering wheel and a steering wheel motor coupled to the steering wheel that the position adjuster adjusts based on a steering wheel command received via the position control touchscreen. The vehicle may include a pedal and a pedal motor coupled to the pedal that the position adjuster adjusts based on a pedal adjustment command received via the position control touchscreen. Additionally or alternatively, the vehicle includes a window and a window motor coupled to the window that the position adjuster adjusts based on a window adjustment command received via the position control touchscreen. Further, the vehicle may include door locks and a door lock actuator coupled to the door locks that the position adjuster actuates based on a door lock actuation command received via the position control touchscreen. In some examples, the vehicle includes a mirror and a mirror motor coupled to the mirror that the position adjuster adjusts based on a mirror adjustment command received via the position control touchscreen. That is, the position control touchscreen enables control of the seat settings, steering wheel settings, pedal settings, window settings, mirror settings, and/or door lock settings.

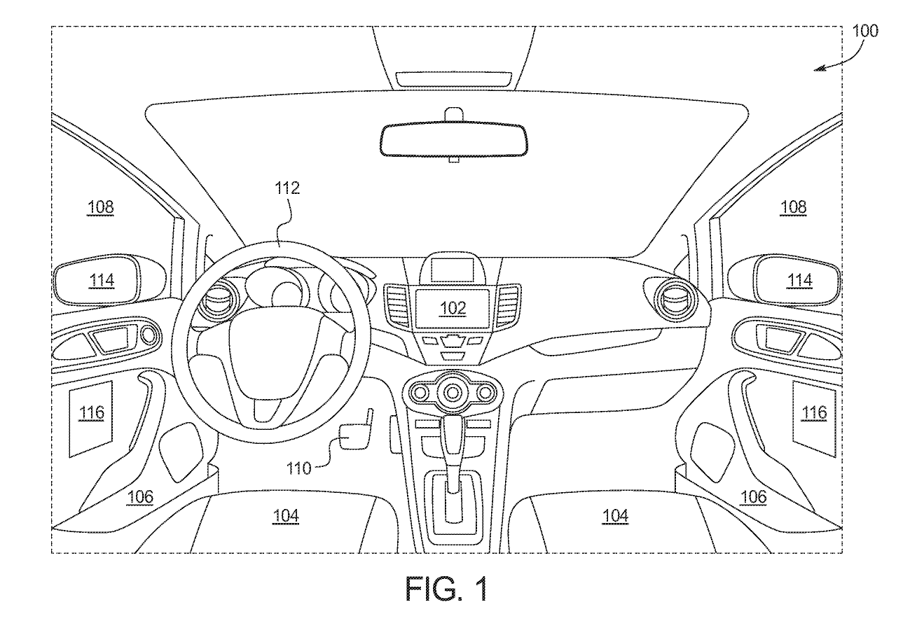

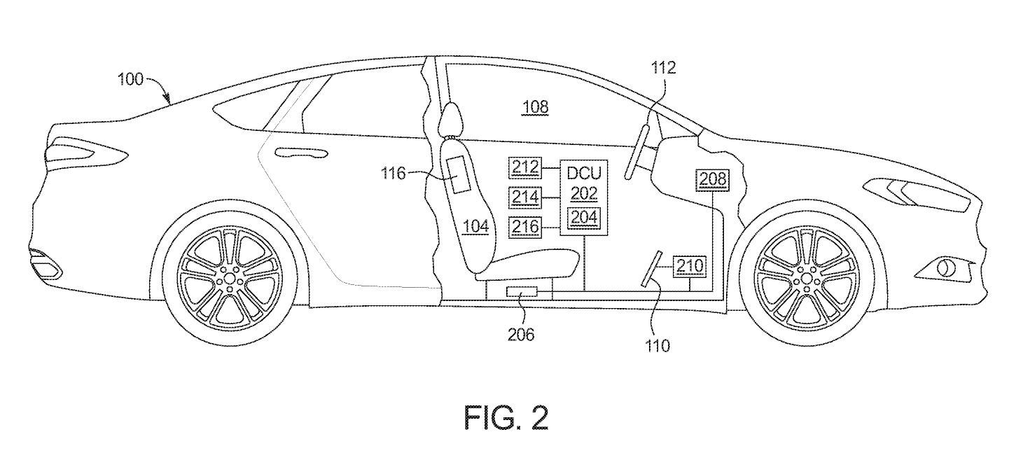

FIGS. 1 and 2 are an interior view and a cutaway view, respectively, of a vehicle 100 with an example touchscreen position adjustment system. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input). As illustrated in FIG. 1, the vehicle 100 includes a center console touchscreen 102, seats 104, doors 106, windows 108, pedals 110, a steering wheel 112, mirrors 114, and position control touchscreens 116. For example, a driver-side of the vehicle 100 includes one of the seats 104, one of the doors 106, one of the windows 108, pedals 110, the steering wheel 112, one of the mirrors 114, and one of the position control touchscreens 116. A passenger-side of the vehicle 100 includes one of the seats 104, one of the doors 106, one of the windows 108, one of the mirrors 114, and one of the position control touchscreens 116.

The center console touchscreen 102 provides an interface between the vehicle 100 and a user for the user to adjust vehicle settings. The center console touchscreen 102 may be any suitable touch-enabled display (e.g. a resistive touchscreen, a capacitive touchscreen, etc.). The center console touchscreen 102 may be accompanied by digital and/or analog interfaces (e.g., input devices and output devices) to receive input from the user(s) and display information. The input devices may include, for example, a control knob, an instrument panel, a digital camera for image capture and/or visual command recognition, an audio input device (e.g., cabin microphone), buttons, and/or a touchpad. The output devices may include instrument cluster outputs (e.g., dials, lighting devices), actuators, a heads-up display, and/or speakers. In the illustrated example, the center console touchscreen 102 is coupled with hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). For example, the center console touchscreen 102 may use pull-down or pop-up menus with a plurality of sub-menus or other multi-layer organizational schemes to provide access to vehicle settings for climate control, navigation, driving modes, communication, the center console touchscreen 102 itself, etc. Additionally, the center console touchscreen 102 displays the infotainment system. In the illustrated example, the center console touchscreen 102 enables one or more users in controlling vehicle settings of the vehicle 100.

The position control touchscreens 116 enable one or more users (e.g. a driver and/or a passenger) to provide commands to control a few designated vehicle devices. In the illustrated example, the vehicle 100 contains a plurality of position control touchscreens 116 (e.g. one corresponding to the driver's seat, one corresponding to the passenger's seat, etc.). In other examples, the vehicle 100 may include more or fewer of the position control touchscreens 116. Further, the position control touchscreens 116 display representations of devices that are adjustable. The position control touchscreens 116 are located adjacent to seats 104 for ease of use. For example, the position control touchscreens 116 may be located on a driver-side door or seat for a driver and/or on a passenger-side door or seat for a passenger. The position control touchscreens 116 may be, for example, resistive touchscreens, capacitive touchscreens, or any other type of touchscreen suitable for displaying images and taking commands via the user's touch. Each of the position control touchscreens 116 may be coupled with hardware (e.g. a processor or controller, memory, storage, etc.) and software (e.g. an operating system). The position control touchscreens 116 are used to provide commands to adjust, for example, the positions of the seats 104, the windows 108, the pedals 110, the steering wheel 112, and the mirrors 114, and/or states of the eLatches 216 (e.g. locked, unlocked). In other examples, the vehicle includes a plurality of the position control touchscreens 116 in which one of the position control touchscreens 116 facilitates control of one or more of the seats 104, one of the position control touchscreens 116 facilitates control of one or more of the doors 106, one of the position control touchscreens 116 facilitates control of one or more of the windows 108, one of the position control touchscreens 116 facilitates control of or more the pedals 110, one of the position control touchscreens 116 facilitates control of the steering wheel 112, and one of the position control touchscreens 116 facilitates control of one or more of the mirrors 114. Further, in some examples, the position control touchscreens 116 enable control of seat settings, window settings, pedal settings, mirror settings, and/or eLatch settings; and the center console touchscreen 102 enables control of the vehicle settings without enabling control of seat settings, window settings, pedal settings, mirror settings, and/or eLatch settings. In other examples, the position control touchscreens 116 enable control of seat settings, window settings, pedal settings, mirror settings, and/or eLatch settings; and the center console touchscreen 102 enables control of the vehicle settings as well as seat settings, window settings, pedal settings, mirror settings, and/or eLatch settings.

As illustrated in FIG. 2 the vehicle 100 further includes a door control unit 202 with a position adjuster 204, seat control motors 206, steering wheel control motors 208, pedal control motors 210, window control motors 212, mirror control motors 214, and electronic latches (eLatches) 216. In the illustrated example, one of the position control touchscreens 116 is coupled to one of the seats 104.

The door control unit 202 contains a position adjuster 204. The door control unit 202 is in communication with the position control touchscreens 116 and motors to adjust the position of corresponding devices in the vehicle 100. For example, the door control unit 202 is in communication with the seat control motors 206 that adjust the position of seats 104 (e.g. seat height, recline angle, etc.), the steering wheel control motors 208 to adjust the position of the steering wheel 112 (e.g. steering wheel angle), the pedal control motors 210 to adjust the position of the pedals 110 (e.g. to position the pedals closer to or farther away from the driver), the window control motors 212 to adjust the position of the windows 108 (e.g. the amount by which the windows are open), and the mirror control motors 214 to adjust the position of the mirrors 114 (e.g. the angle of the mirrors). In the illustrated example, the door control unit 202 additionally is in communication with the eLatches 216 to control door locks.

The position adjuster 204 receives the command from the position control touchscreens 116 and, based on the command, determines and provides instructions to cause the position of one or more of the devices of the vehicle 100 to be adjusted accordingly. When a user enters a command at one of the position control touchscreens 116, the command is received by the position adjuster 204. For example, the command may include the user dragging a representation of the target device on one of the position control touchscreens 116 into a desired position (e.g. dragging the image of the back of one of the seats 104 down in order to cause that one of the seats 104 to recline, dragging an image of one or more of the windows 108 upward or downward to cause one or more of the windows 108 to open or close, dragging an image of the pedals 110 to cause the pedals 110 to move backward or forward, etc.). In some examples, the command includes a selection of a saved user preference (e.g. a preferred seat position).

Upon receiving the command from one of the position control touchscreen 116, the position adjuster 204 determines an instruction (e.g. recline by fifteen degrees) based on the command for the target device (e.g. one of the seats 104 on a driver-side of the vehicle 100). The position adjuster 204 then sends the instruction(s) to one or more motors coupled to the target device to execute the command. In the illustrated example, when the command is for one of the seats 104 to be adjusted, the position adjuster 204 sends the instruction(s) to the seat control motors 206 to cause the seat control motors 206 to adjust one of the seats 104 accordingly. When the command is for one of the windows 108 to be adjusted, the position adjuster 204 sends the instruction(s) to the window control motors 212 to cause the window control motors 212 to adjust one of the windows 108 accordingly. When the command is for the pedals 110 to be adjusted, the position adjuster 204 sends the instruction(s) to the pedal control motors 210 to cause the pedal control motors 210 to adjust the pedals 110 accordingly. When the command is for the steering wheel 112 to be adjusted, the position adjuster 204 sends the instruction(s) to the steering wheel control motors 208 to cause the steering wheel control motors 208 to adjust the steering wheel 112 accordingly. When the command is for the mirrors 114 to be adjusted, the position adjuster 204 sends the instruction(s) to the mirror control motors 214 to cause the mirror control motors 214 to adjust the mirrors 114 accordingly. Additionally, when the command is for the door locks to lock or unlock, the position adjuster 204 sends the instruction(s) to the eLatches 216 to cause the eLatches 216 to actuate.

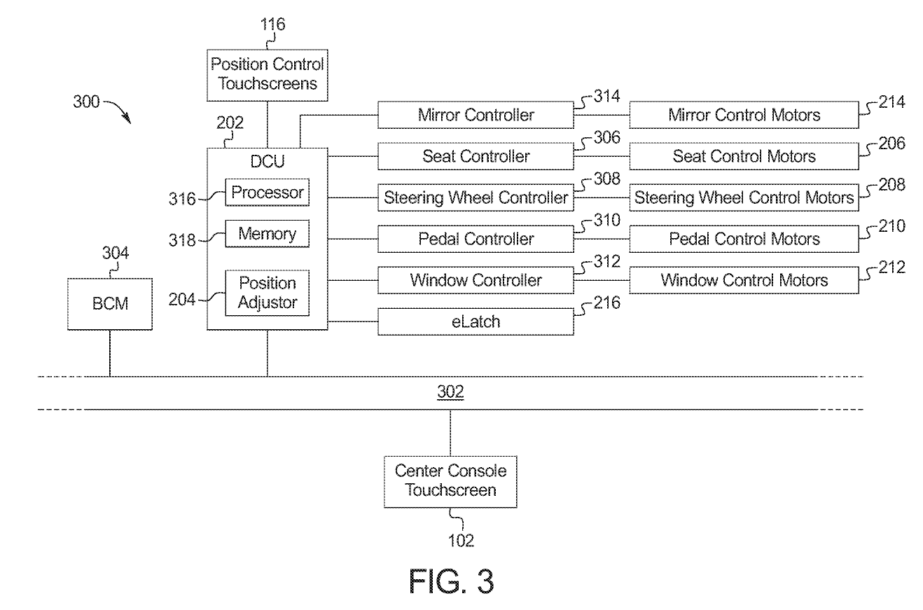

FIG. 3 is a block diagram of electronic components 300 of the vehicle 100 of FIGS. 1 and 2. The example electronic components include a vehicle data bus 302, a body control module 304, the door control unit 202, the position control touchscreens 116, a seat controller 306 and the seat control motors 206, a steering wheel controller 308 and the steering wheel control motors 208, a pedal controller 310 and the pedal control motors 210, a window controller 312 and the window control motors 212, a mirror controller 314 and the mirror control motors 214, the eLatches 216, and the center console touchscreen 102.

The vehicle data bus 302 communicatively couples the body control module 304 and the center console touchscreen 102. In some examples, the vehicle data bus 302 includes one or more data buses. The vehicle data bus 302 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

The body control module 304 controls various subsystems of the vehicle 100. For example, the body control module 304 may control an immobilizer system, air conditioning, heating, windshield wipers, etc. The body control module 304 includes circuits to, for example, drive relays (e.g., to control wiper fluid, etc.), drive brushed direct current (DC) motors (e.g., to control wipers, etc.), drive stepper motors, and/or drive LEDs, etc. The body control module 304 is in communication with the door control unit 202.

The door control unit 202 includes a processor or controller 316 and memory 318. In the illustrated example, the door control unit 202 is structured to include the position adjuster 204. Alternatively, in some examples, the position adjuster 204 may be incorporated into one or more electronic control units (ECU) with their own processor 316 and memory 318 and/or one or more device controllers (e.g., a seat controller, a steering wheel controller, a pedal controller, a window controller, a mirror controller, eLatches, etc.) with their own processor 316 and memory 318. The processor or controller 316 may be any suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs). The memory 318 may be volatile memory (e.g., RAM, which can include non-volatile RAM, magnetic RAM, ferroelectric RAM, and any other suitable forms); non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 318 includes multiple kinds of memory, particularly volatile memory and non-volatile memory.

The memory 318 is computer readable media on which one or more sets of instructions, such as the software for operating the methods of the present disclosure can be embedded. The instructions may embody one or more of the methods or logic as described herein. In a particular embodiment, the instructions may reside completely, or at least partially, within any one or more of the memory 318, the computer readable medium, and/or within the processor 316 during execution of the instructions.

The terms “non-transitory computer-readable medium” and “computer-readable medium” should be understood to include a single medium or multiple media, such as a centralized or distributed database, and/or associated caches and servers that store one or more sets of instructions. The terms “non-transitory computer-readable medium” and “computer-readable medium” also include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

In the illustrated example, the door control unit 202 is in communication with the position control touchscreens 116, the seat controller 306, the steering wheel controller 308, the pedal controller 310, the window controller 312, the mirror controller 314, and the eLatches 216.

The seat controller 306 controls the seat control motors 206 based on instructions from the position adjuster 204. The steering wheel controller 308 controls the steering wheel control motors 208 based on instructions from the position adjuster 204. The pedal controller 310 controls the pedal control motors 210 based on instructions from the position adjuster 204. The window controller 312 controls the window control motors 212 based on instructions from the position adjuster 204. The mirror controller 314 controls the mirror control motors 214 based on instructions from the position adjuster 204. The eLatches 216 actuate the door locks based on instructions from the position adjuster 204.

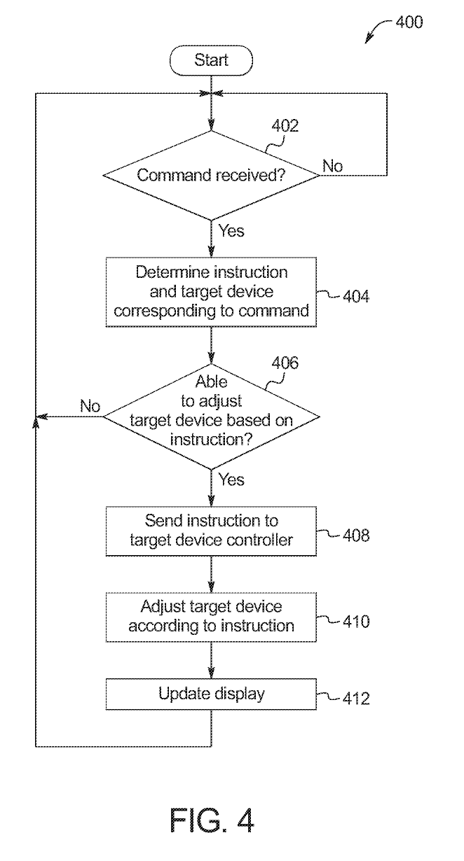

FIG. 4 is a flowchart of a method 400 to implement the touchscreen position adjustment system. The flowchart of FIG. 4 is representative of machine readable instructions stored in memory (such as the memory 318 of FIG. 3) that comprise one or more programs that, when executed by a processor (such as the processor 316 of FIG. 3), cause the vehicle 100 to implement the example position adjuster 204 of FIGS. 2 and 3. Further, although the example program is described with reference to the flowchart illustrated in FIG. 4, many other methods of implementing the example position adjuster 204 may alternatively be used. For example, the order of execution of the blocks may be changed, and/or some of the blocks described may be changed, eliminated, or combined.

Initially, at block 402, the position adjuster 204 determines whether a command has been received. In response to the position adjuster 204 receiving a command, the method proceeds to block 404. Otherwise, in response to the position adjuster 204 not receiving a command, the method 400 remains at block 402 until a command is received. At block 404, the position adjuster 204 determines an instruction (e.g. recline fifteen degrees) and a target device (e.g. passenger's seat) based on the command. For example, when the position adjuster 204 receives a command to recline a seat 104, the position adjuster 204 computes a change in recline angle by comparing a current position of the seat 104 to a requested position of the seat 104.

At block 406, the position adjuster 204 determines whether the instruction can be executed on the target device. For example, an instruction may not be able to be executed when the instruction is structurally unable to do so, such as further reclining one of the seats 104 beyond a fully reclined position. In such instances, the position adjuster 204 detects that the state of the target device (e.g. one of the seats 104 in a fully reclined position, one of the windows 108 in a fully open position, etc.) physically prevents execution of the instruction (e.g. recline, open, etc.). In response to the instruction being able to be executed, the method proceeds to block 408. Otherwise, in response to the instruction not being able to be executed, the method returns to block 402.

At block 408, the position adjuster 204 sends the instruction to the controller corresponding to the target device. At block 410, the controller corresponding to the target device adjusts the target device, via the motors corresponding to the target device, according to the instruction. Further, at block 412, one or more of the position control touchscreens 116 updates the displayed position of the target device to reflect the current position of the target device, after the controller and motors have adjusted the target device. Afterwards, the method 400 returns to block 402.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle comprising:
a center console touchscreen for controlling vehicle settings;
a seat;
a seat motor coupled to the seat;
a position control touchscreen adjacent to the seat for controlling seat settings; and
a position adjuster communicatively coupled to the position control touchscreen to:
receive a seat adjustment command via the position control touchscreen; and
adjust the seat, via the seat motor, based on the seat adjustment command.

2. The vehicle of claim 1, further including a steering wheel and a steering wheel motor coupled to the steering wheel, wherein the position adjuster is to adjust an angle of the steering wheel, via the steering wheel motor, based on a steering wheel adjustment command received via the position control touchscreen.

3. The vehicle of claim 1, further including a pedal and a pedal motor coupled to the pedal, wherein the position adjuster is to adjust a position of the pedal, via the pedal motor, based on a pedal adjustment command received via the position control touchscreen.

4. The vehicle of claim 1, further including a window and a window motor coupled to the window, wherein the position adjuster is to adjust a position of the window, via the window motor, based on a window adjustment command received via the position control touchscreen.

5. The vehicle of claim 1, further including door locks and a door lock actuator coupled to the door locks, wherein the position adjuster is to actuate the door locks, via the door lock actuator, based on a door lock actuation command received via the position control touchscreen.

6. The vehicle of claim 1 including a mirror and a mirror motor coupled to the mirror, wherein the position adjuster is to adjust an angle of the mirror, via the mirror motor, based on a mirror adjustment command received via the position control touchscreen.

7. The vehicle of claim 1, further including a door adjacent to the seat, wherein the position control touchscreen is coupled to the door.

8. The vehicle of claim 1, wherein the position control touchscreen is coupled to the seat.

9. The vehicle of claim 1, wherein the position control touchscreen displays a current position of the seat.

10. The vehicle of claim 1, wherein the seat is a driver seat and the position control touchscreen receives the seat adjustment command for the driver seat.

11. The vehicle of claim 1, further including:
a second seat;
a second seat motor coupled to the second seat; and
a second position control touchscreen adjacent to the second seat for controlling seat settings of the second seat, wherein the position adjuster adjusts the second seat, via the second seat motor, based on a second seat adjustment command received via the second position control touchscreen.

12. The vehicle of claim 1, wherein the position control touchscreen enables control of the seat settings, steering wheel settings, pedal settings, window settings, mirror settings, and door lock settings.

13. A tangible computer readable medium including instructions which, when executed, cause a vehicle to:
receive, via a center console touchscreen, vehicle setting control commands;
receive, via a position control touchscreen, a seat adjustment command;
determine, via a processor, a seat adjustment instruction for a seat motor coupled to a seat based on the seat adjustment command; and
adjust, via the seat motor, a seat setting based on the seat adjustment instruction.

14. The tangible computer readable medium of claim 13, wherein the seat setting includes at least one of a seat height, a seat position, and a recline angle.

15. The tangible computer readable medium of claim 13, wherein the instructions further cause the vehicle to:
receive, via the position control touchscreen, a steering wheel adjustment command;
determine, via the processor, a steering wheel adjustment instruction for a steering wheel motor coupled to a steering wheel based on the steering wheel adjustment command; and
adjust, via the steering wheel motor, a steering wheel setting based on the steering wheel adjustment instruction.

16. The tangible computer readable medium of claim 13, wherein the instructions further cause the vehicle to:
receive, via the position control touchscreen, a pedal adjustment command;
determine, via the processor, a pedal adjustment instruction for a pedal motor coupled to a pedal based on the pedal adjustment command; and
adjust, via the pedal motor, a pedal setting based on the pedal adjustment instruction.

17. The tangible computer readable medium of claim 13, wherein the instructions further cause the vehicle to:
receive, via the position control touchscreen, a window adjustment command;
determine, via the processor, a window adjustment instruction for a window motor coupled to a window based on the window adjustment command; and
adjust, via the window, a window setting based on the window adjustment instruction.

18. The tangible computer readable medium of claim 13, wherein the instructions further cause the vehicle to:
receive, via the position control touchscreen, a door lock actuation command;
determine, via the processor, a door lock actuation instruction for a door lock actuator coupled to a door lock based on the door lock actuation command; and
adjust, via the door lock actuator, a door lock setting based on the door lock actuation instruction.

19. The tangible computer readable medium of claim 13, wherein the instructions further cause the vehicle to:
receive, via the position control touchscreen, a mirror adjustment command;
determine, via the processor, a mirror adjustment instruction for a mirror motor coupled to a mirror based on the mirror adjustment command; and
adjust, via the mirror motor, a mirror setting based on the mirror adjustment instruction.

20. The tangible computer readable medium of claim 13, wherein to receive the seat adjustment command, the instructions cause the vehicle to retrieve a predefined user configuration.
